(19) United States
(12) Patent Application Publication
(10) Pub. No.: US 2004/0138396 A1
(43) Pub. Date: Jul. 15, 2004

(54) Resins and diluents for use in single component low volatile organic

(76) Inventor: Karim M. Gabriel, Lunenburg, MA (US)

Correspondence Address: GROSSMAN, TUCKER, PERREALT & PFLEGER, PLLC, 55 SOUTH COMMERICAL STREET, MANCHESTER, NH, 03101, US

(21) Appl. No.: 10/731,925

(22) Filed: Dec. 9, 2003

Related U.S. Application Data
(60) Provisional application No. 60/439,788, filed on Jan. 13, 2003.

(51) Int. Cl. C08G 77/06

(52) U.S. Cl. 528/17

(57) ABSTRACT

A one-part moisture curable composition comprising an oligomeric or polymeric resin having hydrolysable silyl groups in its molecule, and a organometallic catalyst, wherein the silyl groups are present at an average functionality in the range of 1.0-6.0 to provide crosslinking upon exposure to moisture. In method form, the present invention is directed at a method for coating a substrate which comprises placing the one-part moisture curable composition in a container under substantially anhydrous conditions and then applying the one part moisture curable composition to a substrate surface and crosslinking the composition upon exposure to moisture on the substrate surface.

### CROSS REFERENCE TO RELATED APPLICATIONS

This application claims priority to U.S. Provisional Application No. 60/439,788, filed Jan. 13, 2003.

### FIELD OF THE INVENTION

The present invention is directed at the field of silated polymer resins for use in paint, primers and coatings, characterized by a low volatile organic content. The silated polymer resins are activated upon exposure to moisture and an appropriate catalyst, to thereby provide high molecular weight and highly crosslinked resins for paint, primer and coating applications.

### BACKGROUND OF THE INVENTION

U.S. Pat. No. 6,001,946 discloses compositions useful as sealants, coatings, and the like, based upon urethane prepolymers end-capped with certain N-alkoxysilylalkyl aspartic acid esters, wherein the compositions upon curing are said to form a product having superior elongation, tensile strength and tear resistance in comparison to formulations based on other N-alkosysilylalkyl aspartic acid ester end-capped polymers.

U.S. Pat. No. 6,258,878B1 relates to a one-part, moisture curable composition. Specifically, a one-part moisture-curable composition consisting essentially of 100 parts by weight of a saturated hydrocarbon polymer having on average 1.5 hydrolyzable silyl groups in its molecule, 10 to 300 parts of a silicon-free conduit compound having at least one C6 to C30 hydrocarbon group in its molecule selected from the group consisting of esters, ethers, epoxy-containing compounds, anhydrides and ketones, and a sufficient amount of a silanol condensation catalyst to cure said composition upon exposure to moisture.

Accordingly, it is an object of the present invention to expand upon the above and provide an improved one-part moisture curable composition suitable for use as a paint or coating, and which provides appropriate and relatively high crosslinking density and accompanying advantageous properties associated with such network formation.

### SUMMARY OF THE INVENTION

A one-part moisture curable composition comprising an oligomeric or polymeric resin having hydrolysable silyl groups in its molecule, wherein the silyl groups are present at a concentration that provides crosslinking upon exposure to moisture. Preferably, the average silyl functionality on said oligomer or polymer resin is 1.0, and in the range of 1.0-6.0, and at all 0.1 increments therebetween. Accordingly, average functionality may be, e.g., 1.5, 1.6, 1.7, and higher. The silyl functionality may be associated with a number of different polymer or oligomer type resins suitable for coating applications, including hydrocarbons, esters, ethers, epoxy-containing resins, etc. In addition, the coating formulations may optionally contain other suitable additives associated with coatings, such as pigments and other types of additives to improve coating performance.

### DETAILED DESCRIPTION OF THE PREFERRED EMBODIMENTS

Various resins may be reacted with functional organosilanes to produce silated functionalized precursors for coating applications. In such regard, relatively low molecular weight materials can be functionalized in the same manner to create reactive diluents. The silated polymers and diluents are then cross-linked in the presence of an organometalic catalyst and ambient moisture.

To create paints, primers or other industrial coatings, the silated polymer resins and silated reactive diluents can be combined at various ratios to produce formulations with the desired viscosity and final properties. The combination of the silated reactive diluents and resins create a single component, zero volatile organic content, resin system which acts as the basis for a single component, zero volatile organic content, paint.

### Silated Resins and Silated Diluents

Resins are considered to be any relatively high molecular weight chemical compound that can be blended with pigments, extenders, and diluents to produce a paint, primer or coating. Silated diluents are considered to be relatively lower molecular weight chemical compounds used primarily to reduce the viscosity of the silated resin for a coating application.

The resins and diluents that polymerize herein form a chemical structure which exhibits excellent chemical resistance. This property derives in part from the ability to resist dissolution as a result of the chemical cross links formed during the polymerization reaction. The reaction involves the two identified components, specifically, the resin, which includes high and/or low molecular weight silyl functionalized structure (Part A) and a hardener or curing (organometallic catalyst) (Part B). The two components are preferably kept separate until use and upon combination rapidly polymerize to form a thermoset (crosslinked) material.

In the context of the present invention, silation is the preferred process by which a silane compound (RO₃—SiOH) that is properly functionalized for crosslinking is coupled to a reactive group on any base resin or diluent. Silation then allows the resin to be cured in the presence of an organometelallic catalyst and ambient moisture. By combining silated materials and the catalyst in a dry environment and storing it dry, the silated materials will not polymerize. This material when used as a coating produces a single component thermoset resin.

Silation of the diluent produces a single component reactive diluent that can be copolymerized with the silated resin. The combination of the silated resin and silated diluent produces a base system for the single component coating of the present invention. Furthermore, since the silated resin and silated diluent can react with each other, this material has an overall substantially zero volatile organic content.

Silated diluents can therefore be preferably produced via silation of existing diluents or by the combination of appropriate organosilanes. Examples include, but are not limited to, an epoxy functional and an amine functional silane or a isocyanate functional silane and an amine functional silane. Combinations of these materials will produce relatively low molecular weight liquids that are capable of reacting with the silated resins, previously described.

The resins and diluents herein that can be silated for use in paints, primers, and other industrial coatings include, but are not limited to, polyols, epoxies, urethane prepolymers, polyisocyanates, acrylics, aminoplastics, Furan, Phenolics, Polyvinyl butryal, and silicones.

In this regard, a polyol may be employed. That includes any material with at least one hyrdroxy group. This group also reacts with an isocyante group to produce a urethane. These materials exist in many forms, including, but not limited to: polyesters, polyethers, and polybutadienes. A wide range of molecular weights are available allowing these materials to be used as either diluents or base resins in paints, primers and coatings.

An epoxy functionality may also be employed. This includes any material with at least one epoxide ring. This group may react with an amine, in this application, to assist in thermoset formation. A wide range of materials and molecular weights exist, including, but not limited to, compounds based on bis-phenol A and bisphenol F as well as epoxy novolac materials. These materials can be used as either diluents or base resins in paints, primers and coatings.

Urethane prepolymers may also be employed, which includes any material with at least one or more isocyanate groups. This group reacts with wide a range of materials to produce polymers. When reacted with polyols these materials produce polyurethanes and when reacted with amine terminated materials produce polyureas. A wide range of molecular weights and structures are available allowing these materials to be used as either diluents or base resins in paints, primers and coatings.

Acrylic type materials may also be employed. This relates to a class of materials derived from acrylic acid. A wide range of molecular weights and structures are available allowing these materials to be used as herein as a silyated diluents or silyated base resin in paints, primers and coatings.

Silicone type materials may also be employed, which includes any polymer or compound which consists of —Si(R)₂O— repeating units, wherein R is either an aliphatic, aromatic group, or hydrogen. These materials may be reacted with each other to produce varying molecular weight polysiloxanes and siloxane oligomers. Accordingly, a wide range of molecular weights and structures are available allowing these materials to be used as either silyated diluents or base resins in paints, primers and coatings.

Aminoplastic type resins may also be employed. This includes any polymer or compound with one or more amine groups. A wide range of molecular weights and structures are available allowing these materials to be used as either a silyated diluent or a silyated base resin in paints, primers and coatings. These materials include polyamides, urea-formaldehyde materials, and melamines.

Furan type resins may also be employed. This includes the class of of materials derived from either furfural and furfuryl alcohol. A wide range of molecular weights and structures are available allowing these materials to be used as either a silyated diluent or a silyated base resin in paints, primers and coatings.

Phenolic type resins may also be employed. This includes a class of materials produced by condensation of a phenol, or mixtures of phenol compounds with an aldehyde. A wide range of molecular weights and structures are available allowing these materials to be used as either silyated diluents or silyated base resins in paints, primers and coatings.

Polyvinyl butryal type resins may be employed. This includes a class of materials derived from fully hydrolyzed poly(vinyl alcohol) and butyraldehyde. A wide range of molecular weights and structures are available allowing these materials to be used as either diluents or base resins in paints, primers and coatings.

A generic organosilane which consists of any organic material that is terminated with at least one —Si(R)₂O— group. The preferred embodiment of the inventions utilizes materials manufactured by Osi-Crompton under the tradename Silquest. Other silanes with structures similar to those listed can also be used to produce similar materials. Specific example based on the Silquest product line, include, but are not limited to:

gamma-Isocyanatopropyltriethoxysilane (Silquest A-1310). This material reacts with OH or NH₂ to produce either a silated polyurethane or polyurea, respectively. This material may be used with acrylic, and aminoplastic resins and diluents to produce silated resins or diluents. Additionally, this compound may be used with any materials that react with the functional group to produce silated resins or diluents.

gamma-Aminopropyltriethoxysilane (Silquest A-1100, -1101, -1102), gamma-Aminopropyltrimethoxysilane (Silquest A-1110), Aminoalkyl silicone solution (Silquest A-1106), Modified aminoorganosilane (Silquest A-1108, -1126, -1128), N-beta-(Aminoethyl)-gamma-aminopropyltrimethoxysilane (Silquest A-1120), Triaminofunctional silane (Silquest A-1130), bis-(gamma-trimethsilylpropyl)amine (Silquest 1170), N-Phenyl-gamma-aminopropyltrimethoxysilane (silquest Y-9669), Organomodified polydimethylsiloxane (Silquest Y-11343), Polyazamide silane (Silquest A-1387), and N-beta-(Aminoethyl)-gamma-aminopropyldimethoxysilane (Silquest A-2120). This material may be reacted with acrylic, polyamide, furan, phenolic, urea-formaldehyde, polyvinyl butryal, melamine, polyisocyantes, urethane prepolymers, silicones, and epoxies resins and diluents to produce silated resins or diluents. Additionally, this compound may be used with any materials that react with the functional group to produce silated resins or diluents.

gamma-Mercaptopropyltrimethoxysilane (Silquest A-189), polysufidesiane (Silquest RC-2), and bis-(3[triethoxisilyl]-propyl)-tetrasulfane (Silquest A-1289). This material may be reacted with acrylic, phenolic, polyisocyantes, urethane prepolymers, and epoxies resins and diluents to produce silated resins or diluents. Additionally, this compound may be used with any materials that react with the functional group to produce silated resins or diluents.

beta-(3,4-Epoxycyclohexyl)ethyltriemthoxysilane (Silquest A-186) and gamma-glycidoxypropyltrimethoxysilane (Silquest A-187). This material may be reacted with acrylic, furan, melamine, polyamide, polyurethane, urea-formaldehyde, phenolic, polyisocyantes, and urethane prepolymers resins and diluents to produce silated resins or diluents. Additionally, this compound may be used with any materials that react with the functional group to produce silated resins or diluents.

gamma-Methacryloxypropyltrimethoxysilane (Silquest A-174) This material may be reacted with acrylic and silicone resins and diluents produce silated resins or diluents. Additionally, this compound may be used with any materials that react with the functional group to produce silated resins or diluents.

gamma-Ureidopropyltrialkoxysilane (Silquest A-1160) and gamma-Ureidopropyltrimethoxysilane (Silquest Y-11542). This material may be reacted with acrylic, phenolic, polyamide, polyisocyantes, urethane prepolymers, and urea-formaldehyde resins and diluents to produce silated resins or diluents. Additionally, this compound may be used with any materials that react with the functional group to produce silated resins or diluents.

Vinyltriethoxysilane (Silquest A-151), Vinyltrimethoxysilane (Silquest A-171), Vinyl-tris-(t-methoxyethoxy)silane (Silquest 172), ad Vinylmethyldimethoxysilane (Silquest A-2171). This material may be reacted with silicone resins and diluents to produce silated resins or diluents. Additionally, this compound may be used with any materials that react with the functional group to produce silated resins or diluents.

### Preferred Synthesis of Resins and Diluents

The silation of the resins and diluents preferably consists of four basic steps: 1) addition of reactants, 2) conduction of reaction 3) separation of end product, 4) drying of end product. These steps are preferably conducted in sequence. Alternately, steps 1 and 2 can be conducted and the process halted and the reacted material stored. Steps 3 and 4 can be conducted on the stored material at a later date.

The materials to be silated are selected based on the final desired properties of the coating. The resin or diluent is preferably reacted with a stoichiometric excess of organosilane. Alternately, an excess of resin or diluent can be used.

### Addition of Reactants

The preferred method of addition is to preheat the resin or diluent to be silated and then add the organosilane. In the case where two organosilanes are to be used, the material selected as the stoichiometric excess material should be added last. In both cases, this process may be reversed. The material is added while the resin or diluent temperature is added. The rate of addition is selected such that any exotherm, or uncontrolled rise in temperature is minimized.

### Conduction of Reaction

The reaction is preferably conducted in an inert environment at elevated temperatures. The reaction vessel is flooded with dry nitrogen or other suitable inert gas. A condenser is used to reclaim any reactants that are volatilized during the course of the reaction. The reaction mixture is continuously agitated. The duration and temperature of the reaction is based on the size and heat transfer rate of the reaction vessel. The reaction is continued until the maximum amount of conversion is achieved and is based on the set-up used to conduct the reaction. Conversion can be monitored using chromatographic, spectrographic, or other suitable analytical methods.

### Separation of End Product

The purpose of this step is to preferably remove any volatile organic compounds (organosilane) that have not been fully reacted. This may be done by several means, including but not limited to centrifuge, distillation, or evaporation.

### Drying of End-product

The purpose of this step is to preferably remove any water prior to conversion into a coating. This may be done by several means, including but not limited to centrifuge, distillation, or evaporation. Upon removal of all moisture, the material should be stored with desicant and the container purged with a dry inert gas, such as Nitrogen or Argon

### Paint, Primer, and Coating Formulations

Various combinations of polymers and low molecular weight materials can be silated according to the present invention for moisture curable materials for use in paints, primers and coatings. These materials can be blended in various ratios to produce the base vehicle for paints, primers, and coatings. These materials are then blended with extenders, pigments, stabilizers and other additives to make a coating with the desired film properties. There are four basic steps required to produce the coating: 1) Blending of the additive (part A), 2) Drying part A, 3) Blending the hardener, and 4) Storing with dessicant.

### Blending of the Additives

In this step all of the materials used to create a coating are blended together. The blended product is known as part A. Part A is dried to substantially remove all traces of moisture. Methods for drying include, but are not limited to centrifuge, distillation, or evaporation. The organometallic catalyst is preferably added in this step. This step must be conducted in a substantially dry environment. Sufficient organometallic catalyst is added to effect a cure of the composition upon exposure to moisture. The preferred organometallic catalyst is a tin(IV) carboxlylate, e.g., dibutyltin dilaurate. The amount of catalyst is preferably in the range of 0.05 to 5.0 part for each 100 parts of resin (diluent and polymer) and all 0.05 increments therebetween. Upon completion of this step, but prior to removing from the dry environment, the material is then stored in a container capable of being hermetically sealed. The container preferably includes a dessicant and is packed and sealed in such a manner as to prevent moisture from entering the container during storage.

What is claimed is:

1. A one-part moisture curable composition comprising an oligomeric or polymeric resin having a hydrolysable silyl group, and a organometallic catalyst, wherein said silyl group is present at an average functionality in the range of 1.0-6.0 to provide crosslinking upon exposure to moisture.

2. The one part moisture curable composition of claim 1 wherein said functionality is between 2.0-6.0.

3. The one part moisture curable composition of claim 1 wherein said functionality is greater than 2.0 and up to 6.0.

4. The one part moisture curable composition of claim 1 wherein said organometallic catalyst is a tin (IV) carboxylate.

5. A method for coating a substrate comprising:
(a) providing a container
(b) providing a one-part moisture curable composition comprising an oligomeric or polymeric resin having hydrolysable silyl groups, and a organometallic catalyst, wherein said silyl groups are present at an average functionality in the range of 1.0-6.0 to provide crosslinking upon exposure to moisture;
(c) placing said one-part moisture curable composition in said container under substantially anhydrous conditions;
(d) applying said one part moisture curable composition to a substrate surface
(e) crosslinking said one-part moisture curable composition upon exposure to moisture on said substrate surface to provide a solid crosslinked coating to said surface.
